(19) United States
(12) Patent Application Publication
(10) Pub. No.: US 2018/0054083 A1
(43) Pub. Date: Feb. 22, 2018

(54) SUPPLEMENTAL POWER SYSTEM FOR POWER OVER ETHERNET LIGHTING LUMINARIES

(71) Applicant: Leviton Manufacturing Co., Inc., Melville, NY (US)

(72) Inventor: Robert L. Hick, Newberg, OR (US)

(21) Appl. No.: 15/668,799

(22) Filed: Aug. 4, 2017

Related U.S. Application Data
(60) Provisional application No. 62/376,953, filed on Aug. 19, 2016.

(51) Int. Cl. H02J 9/06; H04L 12/10; H05B 33/08; H05B 37/02

(52) U.S. Cl. CPC H02J 9/06; H04L 12/10; H02J 7/0052; H05B 37/0263; H05B 33/0845

(57) ABSTRACT

A power and control module for a Power over Ethernet (PoE) light emitting diode (LED) lighting system includes an input channel for receiving PoE input power from a PoE switch, an output channel for providing PoE output power to a plurality of LED light fixtures and a power transfer unit coupled between the input and output channel for providing the PoE input power and/or a secondary input power to the output channel as the PoE output power. A secondary power input unit selectively provides secondary power to the power transfer unit. A processor is controls the power transfer unit to adjust an amount of PoE input power and secondary input power to obtain the PoE output power. Secondary input power can be an emergency power source during line power outages. Secondary input power could be a renewable energy power source used preferentially to the PoE input power when available.

### CROSS-REFERENCE TO RELATED APPLICATIONS

This application claims priority to pending U.S. Provisional Patent Application Ser. No. 62/376,953, filed Aug. 19, 2016, titled “Supplemental Power System for Power Over Ethernet Lighting Luminaries,” the entirety of which application is incorporated by reference herein.

### FIELD OF THE DISCLOSURE

The present disclosure relates generally to power arrangements for lighting systems, and more particularly to an improved arrangement for providing power to light emitting diode (LED) lighting systems using Power over Ethernet (PoE).

### BACKGROUND OF THE DISCLOSURE

Power over Ethernet (PoE) is a technology for supplying low voltage current and data over a common point-to-point Ethernet network cable to locations with applications that require both mediums. In some cases, power is carried on the same conductors that carry data. In other cases, power is carried on dedicated conductors within the same cable. Applications that currently benefit from PoE technology include Voice over Internet Protocol (VoIP), Internet Protocol (IP) cameras, wireless local area networks (WLAN), Wireless Access Points (WAP), Building Automation Systems (BAS), and security and access control systems.

PoE currently has two standards: Institute of Electrical and Electronics Engineers (IEEE) 802.3af (the original PoE standard) and IEEE 802.3at (known as PoE plus), which provide, respectively, about 13 Watts and about 25.5 Watts of power to connected devices. PoE has several advantages over traditional power systems used in homes and commercial buildings. For example, PoE systems are relatively low voltage, thus eliminating the need to run expensive high voltage wiring and conduit for lighting. In addition, installation of PoE wiring can be faster than with traditional power systems because Ethernet cabling employs simple plug-in end connections. Where Ethernet cabling is already in place (i.e., for data transmission), PoE functionality can be achieved without the need for additional wiring installation.

Typical cabling for the common IEEE 10base T and 100base T Ethernet specifications use only two (2) pairs of the specified four (4) pair Ethernet cable for transmission of data. The two (2) unused pairs are commonly referred to as the “spare pairs”. Current standards such as, for example, 802.3at and 802.3af provide power only over the two (2) data pairs (i.e., power is not supplied over the spare pairs). As such, under current standards such as, for example, 802.3at and 802.3af, the spare pairs are not used to transmit data or power. New PoE specifications such as UPOE (Cisco Systems) and upcoming standards such as IEEE 802.3bt will allow power to also be provided over the two (2) spare pairs, thus utilizing all wires in the Ethernet cable to provide 51 or more watts of power to the PoE powered devices.

Light emitting diode (LED) luminaires can benefit from connection to a PoE network. Recent advances have reduced the power required to operate LED luminaires to a point where network switches that are compliant with PoE standards such as IEEE 802.3 can supply the power required by the LED luminaires. In addition, digital Ethernet communications can be used to communicate with the luminaire for such uses as to command the LED luminaires to dim and brighten, change color or color temperature, as well as to report status such as lamp failure and energy consumption.

Life Safety code, National Fire Protection Association (NFPA) 101, requires that commercial buildings have a system in place to maintain a minimum amount of illumination in each serviced area for cases in which the normal supply of electrical power is disrupted. This is typically accomplished in one of two ways. In a first approach, a local battery is continuously charged by normal (i.e., building line) electrical power. When the normal electrical power fails, a subset of the total number of luminaires servicing the area are automatically supplied by the local batteries and are forced to turn on to emit enough light to meet the code requirements in the serviced area. In a second approach, the building can have a separate emergency power wiring system that is connected to normal electrical power but which can also be supplied by a central battery or a generator when normal power fails. This emergency power wiring can be connected to a subset of the total number of luminaires servicing each area, and a control device can force those luminaires to emit light when the control device senses that normal power has failed.

Such techniques can be problematic where LED luminaires are powered and controlled by PoE technology. In most systems, the LED luminaires in a particular area are powered by PoE switches located in the building's data centers. The PoE switches themselves may or may not be powered by an uninterruptable power supply (UPS), and where they are not, the PoE switches may deprive the associated LED luminaires of power when the normal power fails. In addition, the PoE switches may not be capable of detecting a failure of normal power and thus they may not signal a small subset of LED luminaires in each serviced area to emit sufficient light when normal electrical power fails. It would, therefore, be desirable to automatically provide uninterrupted power to PoE devices, such as PoE powered LED luminaires, when normal sources of power are unavailable. Such a system would ensure that minimum lighting levels are maintained in serviced areas, despite the loss of normal power.

It would also be desirable to automatically supply PoE powered devices such as LED luminaires with power supplied by alternative power sources, such as sustainable cogeneration electrical power sources.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Disclosed herein is a power and control module for a Power over Ethernet (PoE) light emitting diode (LED) lighting system. The power and control module may include an input channel, an output channel, a power transfer unit, a secondary power input unit, and a processor. The input channel may receive PoE input power from a PoE switch. The output channel may provide PoE output power to a plurality of LED light fixtures. The power transfer unit may be coupled between the input channel and the output channel for providing at least one of the PoE input power and a secondary input power to the output channel as the PoE output power. The secondary power input unit may be coupled to the power transfer unit for selectively providing secondary power to the power transfer unit. The processor may be coupled to the power transfer unit, the processor may be programmed to control the power transfer unit to adjust an amount of the PoE input power and the secondary input power that is provided to the output channel to obtain the PoE output power. In use, the PoE output power is an amount of power sufficient to power the plurality of LED light fixtures to achieve a predetermined brightness of each of the plurality of LED light fixtures.

The secondary input power may be at least one of an emergency power input and an alternative power input. The secondary input power may be an external or internal battery and charging circuit.

The power and control module may also include a PoE voltage detection module for detecting a voltage of the PoE input power. The secondary input power unit may include an emergency power supply for receiving emergency power from an emergency power source and for providing the emergency power to the power transfer unit. The processor may be programmed to: (i) determine when the voltage of the PoE input power is below a predetermined threshold; and (ii) command the power transfer unit to provide the emergency power to the output channel, via the power transfer unit, in order to achieve the PoE output power.

The power and control module may also include a line voltage detection module for detecting a voltage of a line voltage source coupled to the power and control module and the PoE switch.

The secondary input power unit may include an alternative power detection unit for determining an alternative power of the alternative power input and for providing the alternative power to the power transfer unit. The processor may be programmed to: (i) determine when the alternative power is above a predetermined threshold; and (ii) command the power transfer unit to provide the alternative power to the output channel, via the power transfer unit, in order to achieve the PoE output power. The processor may be programmed to: (i) determine when the alternative power is less than the PoE output power; and (ii) command the power transfer unit to provide a portion of the PoE input power to the output channel, via the power transfer unit, so that the combination of the alternative power and the portion of the PoE input power at least equal to the PoE output power. The processor may be programmed to: (i) determine when the alternative power is above below the predetermined threshold; and (ii) command the power transfer unit to provide the PoE input power to the output channel, via the power transfer unit, in order to achieve the PoE output power.

A system for controlling an LED lighting system is also disclosed. The system may include a Power over Ethernet (PoE) switch, a power and control module, a first plurality of LED light fixtures, and a second plurality of LED light fixtures. The PoE switch may include a plurality of output channels. The power and control module may include a plurality of input channels, a plurality of output channels, and a processor coupled there between. The plurality of input channels may be coupled to respective ones of the plurality of output channels of the PoE switch via a first plurality of power and communications links, the power and control module being configured to receive PoE input power from the first plurality of power and communications links and to provide PoE output power to the plurality of output channels of the power and control module. The first plurality of LED light fixtures may be coupled to respective ones of the plurality of output channels of the power and control module via a second plurality of power and communications links. The second plurality of LED light fixtures may be coupled to respective ones of the plurality of output channels of the PoE switch via a third plurality of power and communications links. The processor may be programmed to selectively apply at least one of: (a) the received PoE input power, and (b) an additional source of power, to obtain the PoE output power.

The PoE switch may be a mid-span PoE power source. The PoE output power may be an amount of power sufficient to power the first plurality of LED light fixtures to achieve a predetermined brightness of each of the first plurality of LED light fixtures.

The additional source of power may include an emergency power supply, and the power and control module may further include: (i) an emergency power supply unit for receiving emergency power from an emergency power supply, the emergency power supply being the additional source of power, (ii) a PoE voltage detection module for detecting a voltage of the PoE input power, and (iii) a power transfer unit coupled between the plurality of input channels and the plurality of output channels, the power transfer further coupled to the emergency power supply unit for receiving the emergency power from the emergency power supply and for providing the emergency power to the plurality of output channels of the power and control module.

The processor may be programmed to: (i) determine when the voltage of the PoE input power is below a predetermined threshold; and (ii) command the power transfer unit to provide the emergency power to the output channel, via the power transfer unit, in order to achieve the PoE output power.

The additional source of power may include a renewable power source, and the power and control module may further include a power detection unit for determining a power of the renewable power source and for providing the power from the renewable power source to the power transfer unit.

The processor may be programmed to: (i) determine when the power from the renewable power source is above a predetermined threshold; and (ii) command the power transfer unit to provide the power from the renewable power source to the plurality of output channels of the power and control unit in order to achieve the PoE output power.

The processor may be programmed to: (i) determine when the power from the renewable power source is less than the PoE output power; and (ii) command the power transfer unit to provide a portion of the PoE input power to the plurality of output channels of the power and control module so that the combination of: (a) the power from the renewable power source, and (b) the portion of the PoE input power at least equal to the PoE output power.

The processor may be programmed to: (i) determine when the power from the renewable power source is above below the predetermined threshold; and (ii) command the power transfer unit to provide the PoE input power to the plurality of output channels of the power and control module in order to achieve the PoE output power.

A power and control module for a Power over Ethernet (PoE) light emitting diode (LED) lighting system is also disclosed. The PoE LED system may include an input channel, an output channel, a unit to split out and recombine the non-data wires coupled between the input channel and the output channel, and a secondary power input unit. The input channel may receive PoE input power from a PoE switch. The output channel may provide PoE output power to a plurality of LED light fixtures. The unit to split out and recombine the non-data wires coupled between the input channel and the output channel may provide at least one of the PoE input power and a secondary input power to the non-data wires of the output channel as the PoE output power. The secondary power input unit may be coupled to the non-data wires for selectively providing secondary power to the non-data wires. The PoE output power may be an amount of power sufficient to power the plurality of LED light fixtures to achieve a predetermined brightness of each of the plurality of LED light fixtures.

The secondary input power may be at least one of an emergency power input and an alternative power input. The secondary input power may be an external or internal battery and charging circuit.

The system may also include a PoE voltage detection module for detecting a voltage of the PoE input power on data wires or non-data wires. The secondary input power unit may include an emergency power supply for receiving emergency power from an emergency power source and for providing the emergency power to non-data wires.

The system may further include a line voltage detection module for detecting a voltage of a line voltage source coupled to the power and control module and the PoE switch.

The secondary input power unit may include an alternative power detection unit for determining an alternative power of the alternative power input and for providing the alternative power to the non-data wires.

### BRIEF DESCRIPTION OF THE DRAWINGS

By way of example, a specific embodiment of the disclosed device will now be described, with reference to the accompanying drawings, in which:

FIG. 1 shows an exemplary Power over Ethernet (PoE) lighting system according to the disclosure;

FIG. 2 is a schematic diagram of an exemplary embodiment of a PoE lighting system according to the disclosure;

FIG. 3 is a schematic diagram of an exemplary embodiment of a power and control module for the system of FIG. 2;

FIG. 3A is a schematic diagram of an alternate, exemplary embodiment of a power and control module for the system of FIG. 2;

FIG. 4 is a schematic diagram of an alternate, exemplary embodiment of a power and control module for the system of FIG. 2;

FIG. 5 is an exemplary embodiment of a PoE power supply and injector according to the disclosure;

FIG. 6 is an alternate, exemplary embodiment of a PoE power supply and injector according to the disclosure;

FIG. 7 is an alternate, exemplary embodiment of a power and control module for supplying emergency, backup, supplemental and/or alternative power in a PoE lighting system utilizing the “spare pairs” of wires in an Ethernet cable; and

FIG. 8 is an alternate, exemplary embodiment of a power and control module for emergency, backup, supplemental and/or alternative power in a PoE lighting system utilizing the “spare pairs” of wires in an Ethernet cable.

### DETAILED DESCRIPTION

A system and method are disclosed for supplying power to PoE powered devices such as PoE powered LED light fixtures. The system may include a power and control module for managing the provision of normal and alternate electrical power to one or more PoE powered devices, such as PoE powered LED light fixtures. The power and control module may include a plurality of PoE input ports, a plurality of PoE output ports, for example, a matching plurality of PoE output ports, and internal circuitry for managing power supplied to the connected PoE powered devices. In some embodiments, power may be supplied to the power and control module from one or more of an uninterruptable power source, a battery, an alternating current (AC) or direct current (DC) emergency electrical system, or AC or DC alternative electrical power such as a cogeneration electrical system, or any of a variety of renewable power sources such as solar, thermal, wind or the like.

The power and control module may be connected between one or more PoE switches located in a data center and one or more PoE powered devices. Network wiring from the PoE switch may be connected to the power and control module's input ports. One or more PoE powered LED light fixtures or other PoE powered devices may be connected to the power and control module's output ports and may receive power and/or communications signals via the power and control module.

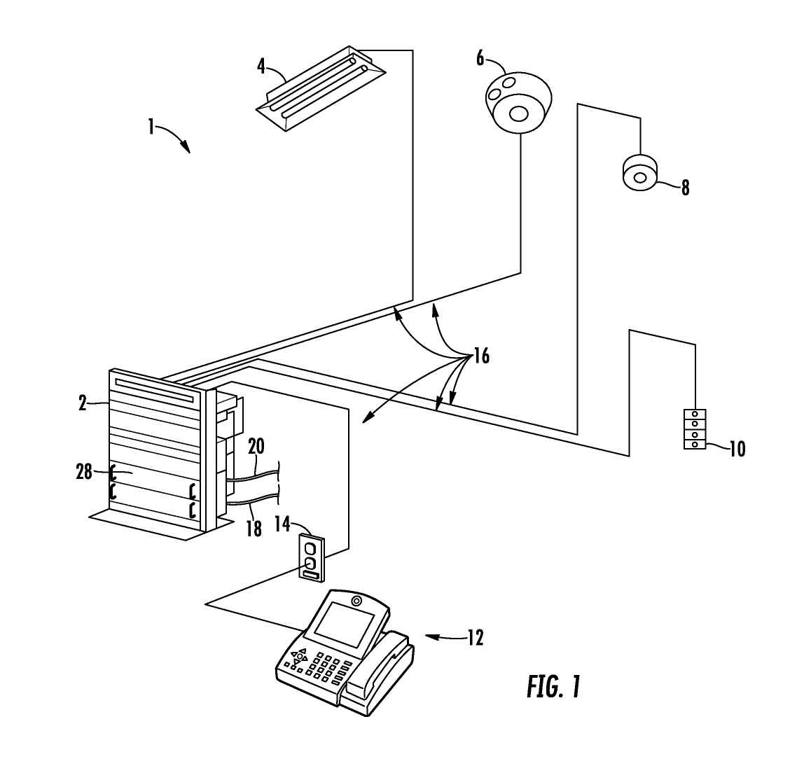

Referring to FIG. 1, a simplified lighting power and control system 1 can include a PoE switch 2 coupled to a plurality of PoE powered devices. In some embodiments, the plurality of PoE powered devices may include an LED light fixture 4, an occupancy sensor 6, a photodetector 8 and a wall switch 10, all of which may be coupled to the PoE switch 2 via power and communications links 16. In alternate embodiments, other PoE powered devices may be used. It will be appreciated that although the illustrated embodiment includes a single LED light fixture 4, occupancy sensor 6, photodetector 8 and wall switch 10, the system 1 can include multiples of each device coupled directly or indirectly to the PoE switch 2. In some embodiments, the PoE switch 2 may also be coupled to communications stations such as an IP phone 12 via a wall plate 14.

Power and communication links 16 between the PoE switch 2 and each of the individual identified connected PoE powered devices can be an appropriate Ethernet cable. In some non-limiting exemplary embodiments, the Ethernet cable is a CAT5 cable, a CAT6 cable, or any other cable type capable of carrying power and control signals. Alternatively, in some embodiments, one or more of the occupancy sensor 6, photodetector 8, wall switch 10, or other information gathering, sensing, and/or control device(s) may be low-voltage devices that do not connect to the PoE switch 2 via an Ethernet cable, but rather connect to the system via appropriate low-voltage wiring.

The PoE switch 2 may include a line power connection 18 for receiving power from a building power source. As will be understood, the PoE switch 2 can be a network switch that has PoE injection (i.e., power injection) built in. That is, the PoE switch 2 takes in line power, conditions it, and injects it onto one or more conductors of the power and communications link 16 to connected PoE powered devices. The PoE switch 2 may also include a network connection 20 for receiving control signals from one or more remote control systems such as a building automation system (BAS). The BAS can be used to monitor and/or control one or more PoE powered devices of the lighting power and control system 1 via the associated power and communications links 16. In the illustrated embodiment, the system 1 can include a line power supply interface 28 for providing power to the PoE switch 2 either directly or via the power distribution unit.

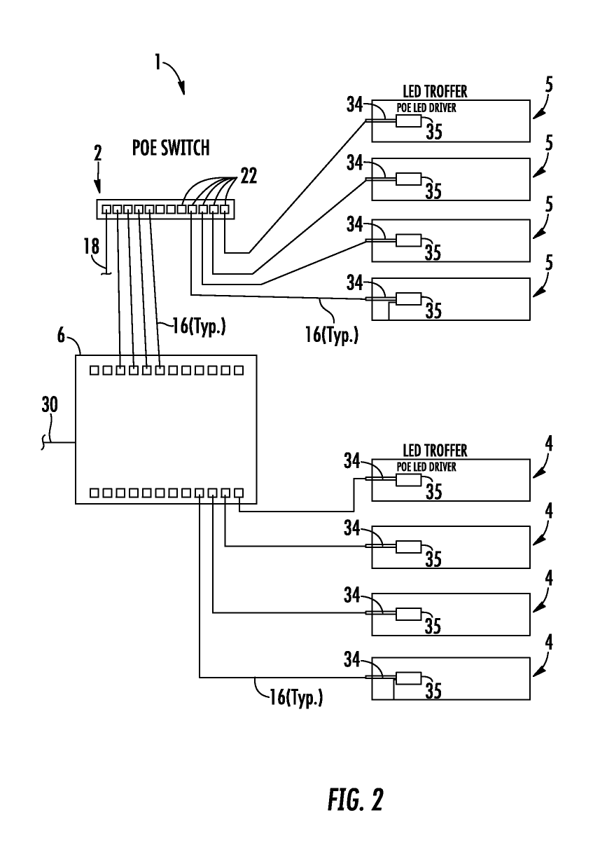

Referring to FIG. 2, an exemplary interconnection arrangement for the components of system 1 further includes a power and control module 6 disposed between the PoE switch 2 and a first plurality of LED light fixtures 4. The PoE switch 2 may have a plurality of output channels 22 which may be coupled, via individual power and communication links 16, to respective input channels 24 of the power and control module 6. Output channels 26 of the power and control module 6 may, in turn, be coupled, via separate power and communication links 16, to the individual LED light fixtures 4 to selectively provide power and communications signals to the LED light fixtures 4.

In some embodiments, a second plurality of LED light fixtures 5 may be coupled directly to separate ones of the plurality of output channels 22 of the PoE switch 2 via individual power and communication links 16. The second plurality of LED light fixtures 5 may be similar to or the same as the first plurality of LED light fixtures 4.

As mentioned, the power and communications links 16 can be CAT5 or CAT6 cables, or any other cable type capable of carrying power and control signals. Connections between the power and communication links 16 and associated components may, for example, be via suitable connectors 34 such as RJ45 connectors.

The PoE switch 2 may be coupled to a source of line power 18, and may provide power to the first and second plurality of LED light fixtures 4, 5 via respective power and communications links 16. For the first plurality of LED light fixtures 4, however, that power may be provided via the power and control module 6 and an additional set of associated power and communications links 16.

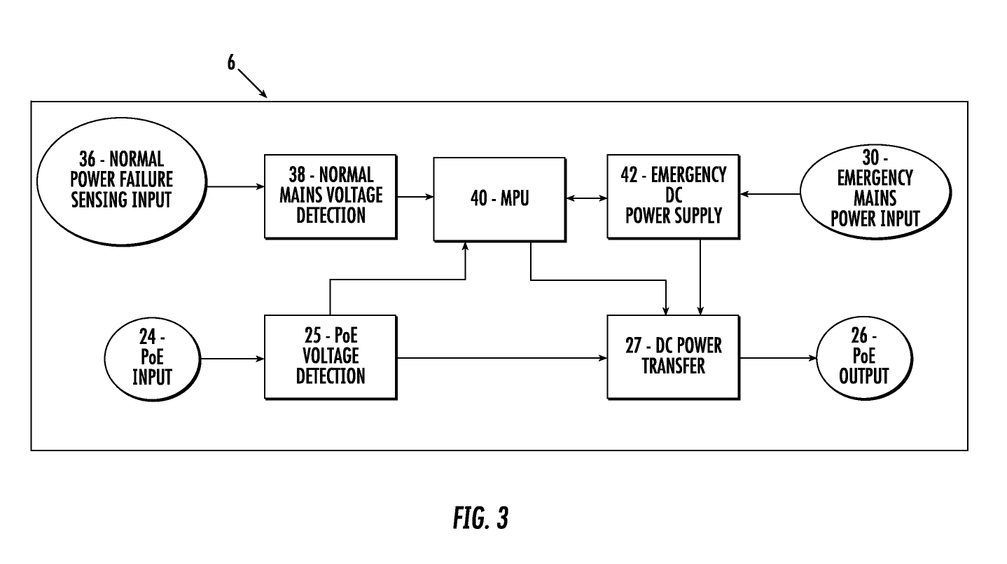

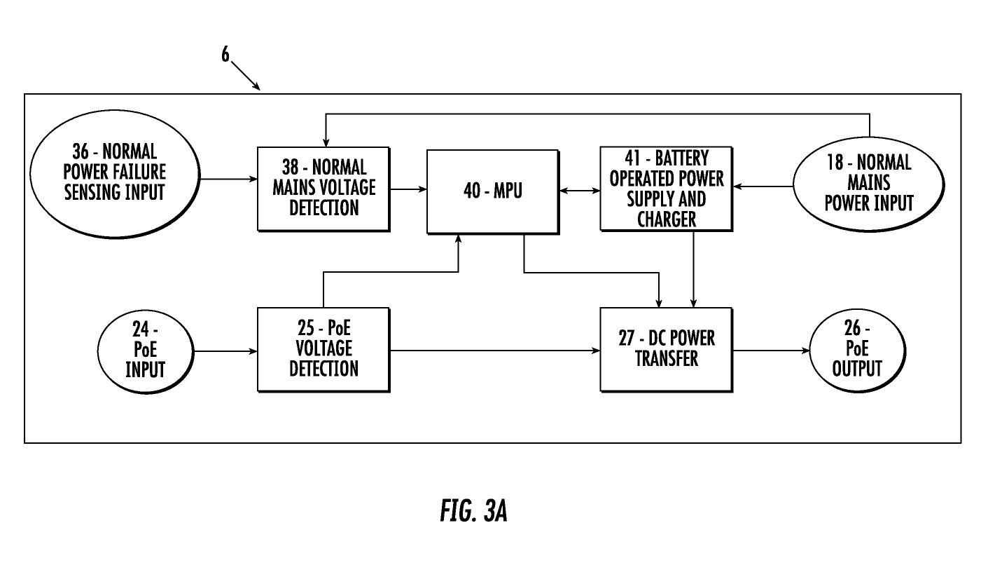

The power and control module 6 may itself be coupled to a source of power via an input power connection. For example, the power and control module 6 may be coupled to line power via a normal main power input 18. Alternatively, and/or in addition, the power and control module 6 may be coupled to an alternate power source (i.e., separate from the line power) via an input power connection such as, for example, to an emergency mains power input 30 as shown in FIGS. 2 and 3. Thus arranged, the power and control module 6 may provide power to the first plurality of LED light fixtures 4 when line power 18 is unavailable.

The source of power supplied to the power and control module 6 via the input power connection (e.g., emergency mains power input 30, normal mains power input 18, etc.) may be an uninterruptible power supply (UPS), a battery power supply, or any of a variety of renewable power sources such as solar, thermal, wind or the like. As will be described in greater detail later, the power supplied to the power and control module 6 may be used to supplement the source of line power 18 supplied to the PoE switch 2 and/or may be used to power and control one or more of the LED light sources 4 when the source of line power is unavailable due to a system outage.

In some embodiments, the separate source of power via the input power connection (e.g., emergency mains power input 30, normal mains power input 18, etc.) may also be used preferentially to provide power to the first plurality of LED light fixtures 4. For example, where the separate source of power is a renewable power source (e.g., solar power) it may be desirable to have the separate source of power via the input power connection (e.g., emergency mains power input 30, normal mains power input 18, etc.) supply power to the first plurality of LED light fixtures 4 with solar power rather than line power 18 to, for example, save energy costs.

To power and control the individual lighting elements of the system 1, at least one of the plurality of LED light fixtures 4 can include a PoE LED driver 35 to condition the power received from the PoE switch 2 and to receive and react to control signals received from a control source such as the wall switch 10. The PoE LED driver 35 may receive command signals via the PoE switch 2 and/or the power and control module 6 and may control the connected first and second light fixtures 4, 5 accordingly. In the illustrated embodiment, the PoE LED drivers 35 of the first plurality of LED light fixtures 4 are connected to the PoE switch 2 via the power and control module 6 (again, via respective power and communications links 16), while the second plurality of LED light fixtures 5 are directly connected to the PoE switch 2 via the power and communications links 16. The PoE LED driver 35 may be the same as or similar to the PoE LED driver described in U.S. Pat. No. 9,295,142, titled, “Power over Ethernet Lighting System,” issued to Leinen et al, which is hereby incorporated by reference.

In some embodiments, the PoE switch 2 and the plurality of LED light fixtures 4, 5 may be located remotely from each other. For example, the PoE switch 2 may be located within a data center of a building, which the plurality of LED light fixtures 4, 5 may be distributed about the building in one or more rooms or external areas of the building. In addition, it will be appreciated that although the illustrated embodiment shows only four LED light fixtures 4 coupled to the PoE switch 2 and the power and control module 6, in practical application a large number of LED light fixtures located in various rooms and external areas of a building can be powered and controlled by a single PoE switch and power and control module.

Referring now to FIG. 3, a non-limiting exemplary embodiment of a power and control module 6 will be described in greater detail. In this embodiment, the power and control module 6 may be configured to provide emergency PoE power to connected PoE powered devices (e.g., first plurality of LED light fixtures 4) for instances in which insufficient power is provided via the PoE switch 2. Examples of such instances include failures in line power (e.g., power outages) or failures in the PoE switch 2. Thus, in the illustrated embodiment the power and control module 6 can be configured as an emergency PoE power supply for the first plurality of LED light fixtures 4, as well as any other PoE powered device connected to the power and control module 6.

It will be appreciated that only the first plurality of LED light fixtures 4 (i.e., those LED light fixtures that are coupled to the power and control module 6) will receive such emergency power. Thus, in some embodiments, the first plurality of LED light fixtures 4 may be designated for emergency lighting use. This means that the first plurality of LED light fixtures 4 may be positioned within serviced areas in order to provide light levels to those areas in order to meet applicable building codes. For example, in one non-limiting exemplary embodiment, each LED light fixture of the first plurality of light fixtures 4 may be located within a different area of a building in order to provide a desired minimum lighting level in those areas to comply with applicable safety codes. It will be appreciated that depending on the size of the serviced area, more than one LED light fixture of the first plurality of light fixtures 4 may be located in a particular area, with the total number of fixtures per area dictated by the applicable safety code.

In the embodiment illustrated in FIG. 3, the power and control module 6 includes a PoE input channel 24 for coupling to a respective output channel 22 (FIG. 2) of the PoE switch 2 via a power and communications link 16. The power and control module 6 also includes a PoE output channel 26 for coupling to a respective one of the first plurality of LED light fixtures 4 via a power and communications link 16. It will be appreciated that although the description will proceed in relation to a single PoE input channel 24 and a single PoE output channel 26, in practical application the power and control module 6 will include a plurality of PoE input and output channels so that the power and control module 6 can power and control any number of first plurality of LED light fixtures 4, or other connected PoE powered devices.

The PoE input channel 24 may be coupled to a PoE voltage detection unit 25 which may be used to monitor PoE power provided from the PoE switch 2 and to determine if the PoE power is sufficient to power all of the first plurality of LED light fixtures 4. The PoE voltage detection unit 25 may be coupled to a microprocessor (MPU) 40, and in some embodiments the MPU 40 may be programmed to determine, via the PoE voltage detection unit 25, whether the power received from the PoE switch 2 is sufficient to power the first plurality of light fixtures 4. Alternatively, the voltage detection unit 25 may itself determine the sufficiency of the power received from the PoE switch 2 and may provide appropriate signals to the MPU 40 if the received power is determined to be insufficient.

A DC power transfer unit 27 may be coupled between the PoE voltage detection unit 25 and the PoE output channel 26 so that power received from the PoE switch 2 can be provided to the first plurality of LED light fixtures 4. The DC power transfer unit 27 can be coupled to the MPU 40 in a manner sufficient to enable the MPU 40 to control operation of the DC power transfer unit 27. It will be appreciated that the DC power transfer unit 27 may also be configured to operate autonomously and provide emergency power to PoE LED light fixtures 4 when the PoE voltage detection unit 25 has detected a loss of sufficient power received from the PoE switch 2 and the MPU unit 40 has failed to operate, making the power on control unit fail-safe.

The power and control module 6 may also include an input power connection. For example, the power and control module 6 may, in addition to receiving line power 18, include an emergency mains power input 30 for receiving input power from an emergency supply of power such as an uninterruptible power supply (UPS), battery power supply, or any of a variety of renewable power sources such as solar, thermal, wind or the like. In this embodiment, the power and control module 6 may also incorporate an emergency DC power supply 42 to condition the received incoming emergency mains power. The DC power supply 42 may convert the incoming voltage to approximately 50 VDC to supply power to the connected PoE powered devices. As illustrated, the power and control module 6 may also incorporate a normal power failure sensing input 36 coupled to a normal mains voltage detection unit 38 for connecting directly to line power (e.g., line power 18 shown in FIG. 1). MPU 40 may be communicatively coupled to the normal mains voltage detection unit 38 and may be programmed to determine when line power 18 has failed. The MPU 40 may also receive operational power via the emergency mains power input 30.

Alternatively, referring to FIG. 3A, the power and control module 6 may include a normal mains power input 18 (e.g., no emergency mains power input 30). In this embodiment, the power and control module 6 may include a battery-operated power supply and charger 41 coupled with the normal mains power input 18 so that, under normal operating conditions, power received by the power and control module 6 can be used to, inter alia, charge the battery-operated power supply and charger 41. As described above, the power and control module 6 may also incorporate a normal power failure sensing input 36 coupled to a normal mains voltage detection unit 38 for connecting directly to line power (i.e., line power 18). MPU 40 may be communicatively coupled to the normal mains voltage detection unit 38 and may be programmed to determine when line power 18 has failed or is providing insufficient power to supply the first plurality of LED light fixtures 4. The MPU 40 may also receive operational power via the normal mains voltage detection unit 38. When the MPU 40 determines that the line power 18 has failed or is providing insufficient power, the MPU 40 may direct the battery-operated power supply and charger 41 to supply emergency power to the first plurality of LED light fixtures 4.

As mentioned, the MPU 40 may be communicatively coupled to the emergency DC power supply 42 (FIG. 3) or the battery-operated power supply and charger 41 (FIG. 3A) to receive emergency or backup operational power. The emergency DC power supply 42 (FIG. 3) or the battery-operated power supply and charger 41 (FIG. 3A) may also be coupled to the DC power transfer unit 27 so that emergency or backup power can be provided to the plurality of first LED light fixtures 4 via the output channels 26 when the power received from the PoE switch 2 is determined to be insufficient.

Thus arranged, the MPU 40 may detect the loss of PoE power supplied from the PoE switch 2 via the PoE voltage detection unit 25 and/or a loss of normal electrical power via the normal mains voltage detection unit 38. In either case, the MPU 40 may command the emergency DC power supply 42 (FIG. 3) or the battery-operated power supply and charger 41 and/or DC power transfer unit 27 to supply operational power to the first plurality of LED light fixtures 4 using emergency operational power received via power connection, for example, emergency mains input connection 30. The DC power transfer unit 27 may also detect a loss of sufficient power received and failure of the MPU unit 40 and operate autonomously to provide emergency power to the first plurality of PoE LED light fixtures 4.

In some embodiments, the MPU 40 may signal the first plurality of LED light fixtures 4 to emit light such that the lighting levels in the serviced area satisfy the applicable safety code(s). In such embodiments, the DC power transfer unit 27 may communicatively couple the MPU 40 to the PoE LED drivers 35 of each of the first plurality of LED light fixtures 4, via respective power and communications links 16. Thus arranged, the MPU 40 can transmit a signal to the PoE LED drivers 35 via the power and communications links 16, and that signal may cause the first plurality of LED light fixtures 4 to emit light. Alternately, in some embodiments the PoE LED drivers 35 may be configured to cause their associated LED light fixtures 4 to emit light upon loss of a digital signal from the MPU 40 or other independent source. In such cases, the DC power transfer unit 27 may simply interrupt transmission of the digital signal to cause the LED light fixtures 4 to emit light. In some embodiments, the emitted light from the plurality of LED light fixtures 4 may be less than a normal emitted light level of the plurality of LED light fixtures. In other embodiments, the emitted light from the plurality of LED light fixtures 4 may be the same as, or greater than, a normal emitted light level of the plurality of LED light fixtures.

When the MPU 40 determines that the power supplied from the PoE switch 2 is sufficient to power the plurality of first LED light fixtures 4, or when normal line power 18 is determined to have returned, the MPU may command the emergency DC power supply 42 (FIG. 3) or the battery-operated power supply and charger 41 and/or the DC power transfer unit 27 to cease providing emergency operational power from the input power connection so that operational power may once again be provided to the first plurality of LED light fixtures 4 from the PoE switch 2.

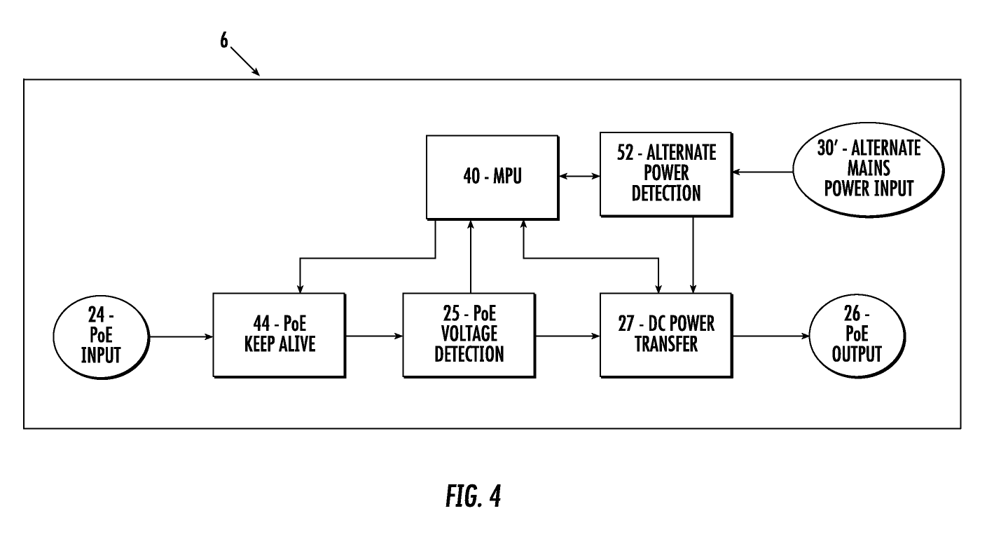

Referring now to FIG. 4, a further non-limiting exemplary embodiment of power and control module 6 will be described in greater detail. In this embodiment, the power and control module 6 may be configured to enable the first plurality of LED light fixtures 4 to be powered by sources of power other than, or supplementary to, line power 18. With this embodiment, the first plurality of LED light fixtures 4 need not be an “emergency lighting” subset of all LED light fixtures used to serve a particular area. Thus, with the instant embodiment all LED light fixtures used to serve a particular area may be coupled to respective output channels 26 of the power and control module 6 so that they may all be preferentially and selectively powered using alternative power sources. For convenience, however, the LED light fixtures coupled to the power and control module 6 will still be referred to as the first plurality of LED light fixtures 4.

In the embodiment illustrated in FIG. 4, the power and control module 6 includes a PoE input channel 24 for coupling to a respective output channel 22 (FIG. 2) of the PoE switch 2 via a power and communications link 16. The power and control module 6 also includes a PoE output channel 26 for coupling to a respective one of the first plurality of LED light fixtures 4 via a power and communications link 16. As with the previous embodiment, it will be appreciated that although the description will proceed in relation to a single PoE input channel 24 and a single PoE output channel 26, in practical application the power and control module 6 will include a plurality of PoE input and output channels so that the power and control module 6 can power and control any number of first plurality of LED light fixtures 4, or other connected PoE powered devices.

The PoE input channel 24 may be coupled to a PoE keep alive unit 44, which may be used to draw very short bursts of current from the PoE switch 2 so that the PoE switch 2 is satisfied that the power and control module 6 and/or the plurality of LED light fixtures 4 are still present and does not cease providing power. The PoE keep alive unit 44 may be coupled to a PoE voltage detection unit 25 which may be used to monitor PoE power provided from the PoE switch 2 and to determine if the PoE power is sufficient to power all of the first plurality of light fixtures 4. The PoE keep alive unit 44 may also be configured to communicate digitally to the PoE switch 2 to control the amount of PoE power delivered by the PoE switch 2, including turning off the PoE power while maintaining the data connection if sufficient power is being supplied by the input power connection (e.g., alternate mains power input 30′). The PoE voltage detection unit 25 may be coupled to a microprocessor (MPU) 40, and in some embodiments, the MPU 40 may be programmed to determine, via the PoE voltage detection unit 25, the sufficiency of the power received from the PoE switch 2. Alternatively, the voltage detection unit 25 may determine the sufficiency of the power received from the PoE switch 2 and may provide appropriate signals to the MPU 40 if the received power is determined to be insufficient. In some embodiments, the MPU 40 can receive operational power from the PoE voltage detection unit 25.

A DC power transfer unit 27 may be coupled between the PoE voltage detection unit 25 and the PoE output channel 26 so that power received from the PoE switch 2 can be selectively provided to the first plurality of LED light fixtures 4. The DC power transfer unit 27 can be coupled to the MPU 40 in a manner sufficient to enable the MPU 40 to control operation of the DC power transfer unit 27.

The MPU 40 may further be communicatively coupled to an alternative DC power detection unit 52 to receive alternative operational power via input power connection (e.g., alternate mains power input 30). The alternative DC power detection unit 52 may also be coupled to the MPU 40 and the DC power transfer unit 27 so that alternative power can be provided to the plurality of first LED light fixtures 4 via the output channels 26.

Thus arranged, when the MPU 40 determines, via the alternative DC power detection unit 52, that sufficient alternative power is available to provide a portion of the power required by the first plurality of LED light fixtures 4, the MPU 40 may command the DC power transfer unit 27 to supply power from the alternative power source via input power connection (e.g., alternate mains power input 30). In some embodiments, where the alternative power source can provide all of the power required by the first plurality of LED light fixtures 4, then all of the power supplied to those fixtures 4 via output channels 26 may be from the alternative power source. In other embodiments, where the MPU 40 determines that the alternative power source can provide only a portion of the power required by the first plurality of LED light fixtures 4, then the MPU 40 may command the DC power transfer unit 27 to supplement the alternative power with power received from the PoE switch 2 via input channel 24. In this way, the MPU 40 may control the amount of line power 18 used to power the first plurality of LED light fixtures 4 in a manner that maximizes use of the alternative power supply while still ensuring that sufficient power is provided to the first plurality of LED light fixtures 4.

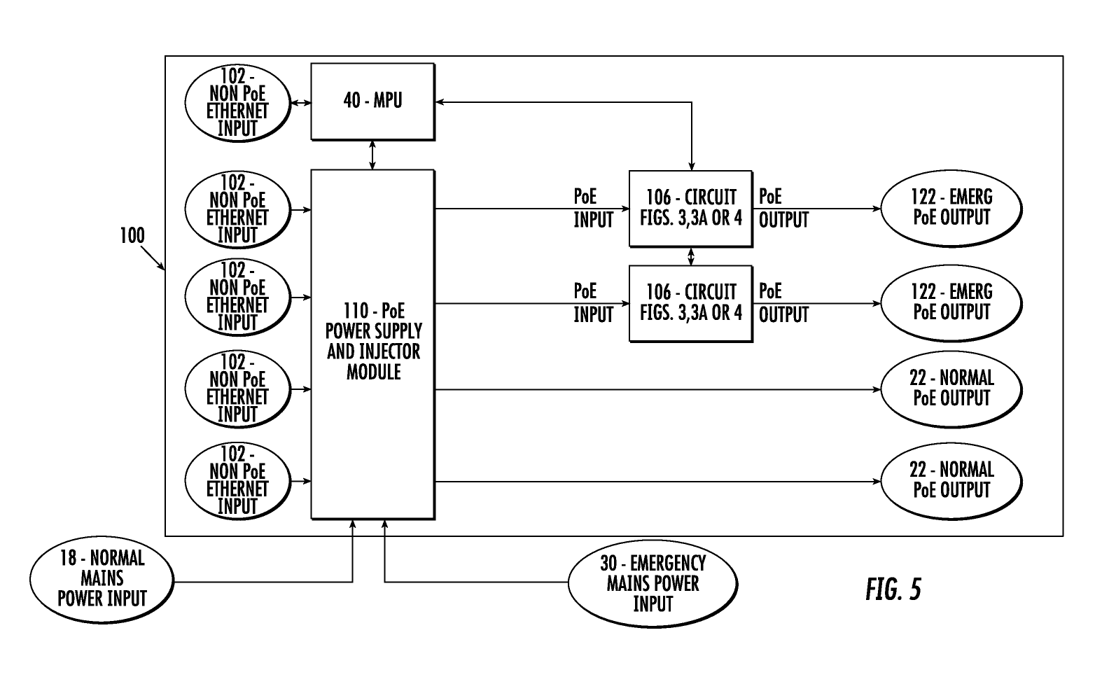

FIG. 5 illustrates an alternate embodiment of a PoE lighting system. As much of the circuity and components of this embodiment is similar to those previously described above, description of the individual elements is hereby omitted for brevity. In connection with FIG. 5, the PoE lighting system includes a PoE power supply and injector 100 for providing emergency, backup, supplemental and/or alternative power. In this embodiment, the circuity and functionality previously associated with the PoE switch 2 (or midspan PoE power source) schematically illustrated in FIGS. 1 and 2 and the circuity and functionality previously associated with the power and control module 6 illustrated in FIGS. 3, 3A and 4 are incorporated into the PoE power supply and injector 100.

As such, in use, the PoE power supply and injector 100 includes a PoE power supply injector module 110 containing circuity for enabling functionality similar to known PoE switches 2 (or midspan PoE power sources). In addition, the PoE power supply and injector 100 further includes a power and control module 106 containing circuity for enabling functionality relating to providing emergency and/or supplemental power to one or more PoE connected devices, as described herein in connection with the power and control module 6 shown in FIGS. 3, 3A, 4, 7 and 8. That is, the PoE power supply and injector 100 may include all of the circuity and functionality previously encompassed within the PoE switch 2 and all of the circuity and functionality previously encompassed with the power and control module 6. For example, the PoE power supply and injector 100 may include a line power connection for receiving power from a building power source. The PoE power supply and injector 100 may take the line power, condition it, and inject it onto one or more conductors of the power and communications link to connected PoE powered devices. The PoE power supply and injector 100 may also include one or more network connections for receiving control signals from one or more remote control systems such as a building automation system (BAS). For example, the PoE power supply and injector 100 may include one or more standard Ethernet input or data connectors 102 for receiving and sending, for example, data.

The PoE power supply and injector 100 may also include a connection for coupling to a separate source of power (i.e., separate from normal mains power input 18) via input power connection, for example, emergency mains power input 30. Thus arranged, as described above, by employing an input power connection (e.g., an emergency mains power input 30), the PoE power supply and injector 100 may provide power to the PoE connected devices (e.g., plurality of LED light fixtures) when line power 18 is unavailable, or to supplement line power, as discussed above.

The PoE power supply and injector 100 may include a plurality of output channels 22 which may be coupled, via individual power and communication links, to respective PoE powered devices (e.g., individual second LED light fixtures 5 (FIG. 2)) to selectively provide power and communications signals to the PoE powered devices (e.g., individual LED light fixtures 5 (FIG. 2)), as previously discussed.

In addition, the PoE power supply and injector 100 may include a plurality of output channels 122 which may be coupled, via individual power and communication links, to respective PoE powered devices (e.g., individual first LED light fixtures 4 (FIG. 2)) to selectively provide power and communications signals to the PoE powered devices (e.g., individual LED light fixtures 4 (FIG. 2)), as previously discussed. The power and communication signals being processed through the power and control module 106 prior to exiting the output channels 122. In this manner, as previously discussed, the power and control module 106 may detect, monitor, control, etc. when a loss or insufficient power condition exists.

Thus arranged, similar to the power and control module 6 discussed above, the power and control module 106 may detect the loss of or insufficient power supply via the normal electrical power (i.e. line power or normal mains power input 18). In response, the power and control module 106 may command the emergency DC power supply or the battery power supply unit and/or DC power transfer unit, as previously described in connection with FIGS. 3, 3A, and 4 to supply operational power to one or more LED light fixtures using emergency operational power received via the emergency mains power input 30.

By connecting the PoE powered devices (e.g., individual LED light fixtures 4) via the power and control module 106, the PoE power supply and injector 100 is able to detect when a loss of power or insufficient power is supplied. By connecting the PoE power supply and injector 100 to the PoE powered devices (e.g., individual LED light fixtures 4) via a power and control module 106, similar to above, the PoE power supply and injector 100 may be configured to provide emergency PoE power to connected PoE powered devices (e.g., first plurality of LED light fixtures 4) thru the power and control module 106 when, for instance, insufficient or loss of power is provided via the PoE power supply and injector 100.

Thus, in the illustrated embodiment the power and control module 106 can be configured to supply emergency, or supplemental, PoE power supply for a first plurality of LED light fixtures 4, as well as any other PoE powered devices connected to the PoE power supply and injector 100 thru the power and control module 106.

It will be appreciated that only the plurality of LED light fixtures that are coupled to the PoE power supply and injector 100 thru the power and control module 106 will receive emergency, or supplemental, power. Thus, as previously described, this plurality of LED light fixtures 4 may be designated for emergency lighting use.

As previously described, the power and control module 106 may include, as appropriate (and as shown in FIGS. 3, 3A and/or 4), a PoE input channel 24, a PoE output channel 26, a PoE voltage detection unit 25, one or more MPUs 40, a DC power transfer unit 27, an emergency DC power supply 42, a normal power failure sensing input 36, a normal mains voltage detection unit 38, a battery-operated power supply and charger 41, a PoE keep alive unit 44, an alternative DC power detection unit 52, etc.

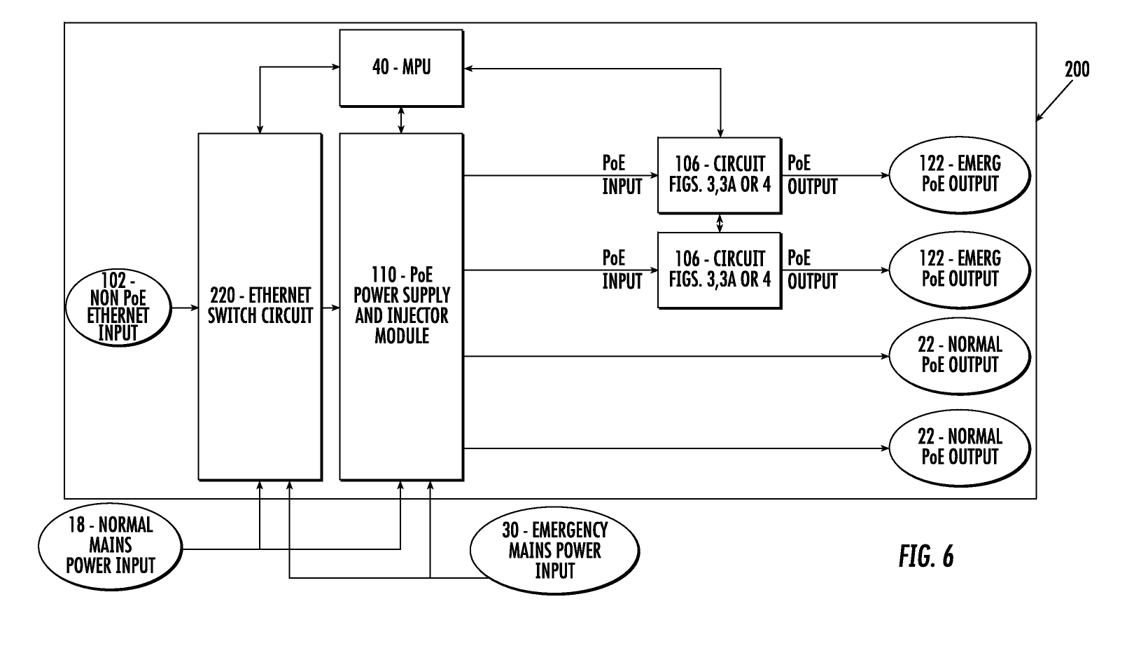

FIG. 6 illustrates an alternate, exemplary embodiment of a PoE power supply and injector 200 for providing emergency, backup, supplemental or alternative power to a PoE lighting system. As the PoE power supply and injector 200 is substantially similar to the PoE power supply and injector 100 discussed above in connection with FIG. 5, a general discussion of the elements, circuity and functionality is hereby omitted for brevity except for noted differences.

Referring to FIG. 6, the PoE power supply and injector 200 may include an Ethernet switch 220. In use, the Ethernet switch 220 may receive a single data input for receiving, for example, control signals from one or more remote control systems such as a BAS (e.g., via non-PoE Ethernet input 102). In use, the Ethernet switch 220 may receive the single input and break the input into any number of outputs, for example, 4, 8, etc. outputs. In addition, the Ethernet switch 220 may be used to communicate data to and from a BAS for testing and reporting. As illustrated, the Ethernet switch 220 may also receive line power from a normal mains power input 18 and emergency power from an emergency mains power input 30, and provide PoE outputs with emergency power backup to operate light fixtures selected for emergency lighting and without emergency power backup for remaining light fixtures.

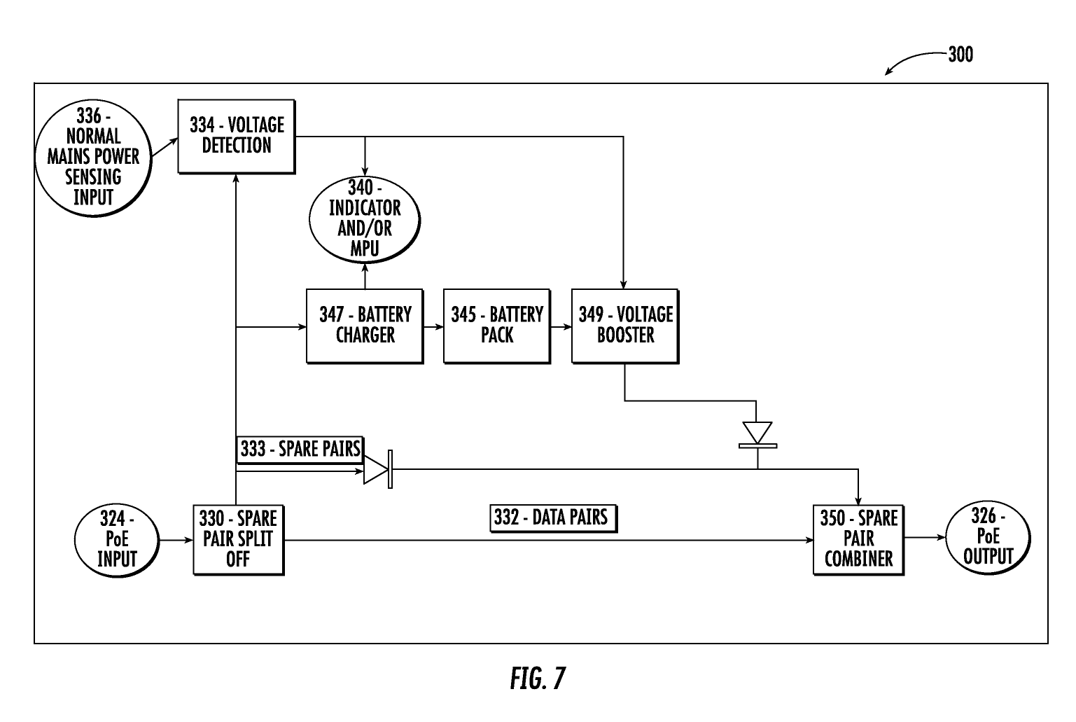

FIG. 7 illustrates an alternate, exemplary embodiment for the circuit in FIG. 3A, supplying emergency, backup, supplemental and/or alternative power by utilizing only the spare pairs of a cable (i.e. four pair (4P) 10base T or 100base T PoE cable) with less dependence on an MPU. As previously mentioned, a typical power and communications link may include four pairs of Ethernet cable located therein. However, in accordance with current IEEE Ethernet specifications for 10base T and 100base T only two pairs of the specified four pairs of Ethernet cable may be used for transmitting data, and current PoE standards allow power to be carried on this same data pairs. The remaining two unused non-data pairs are commonly referred to as the “spare pairs”. In accordance with new PoE specifications, transmission of additional power will be permitted on the two non-data spare pairs along with transmission of power over the data pairs. This in also known as 4 pair PoE or 4P.

Referring to FIG. 7, the PoE lighting system may include a 4P power and control module 300. The 4P power and control module 300 may include one or more PoE input channels 324 for receiving PoE power by, for example, coupling to a respective output channel 22 (FIG. 2) of the PoE switch 2 via a power and communications link 16 (FIG. 2). The 4P power and control module 300 may also include one or more PoE output channels 326 for coupling to a respective PoE controlled device (e.g., an LED light fixture) via a power and communications link. It will be appreciated that although the description will proceed in relation to a single PoE input channel 324 and a single PoE output channel 326, in practical applications the 4P PoE controller module 300 may include a plurality of PoE input and output channels so that the 4P PoE controller module 300 can power and control any number of LED light fixtures, or other connected PoE powered devices. It will also be appreciated that this embodiment does not depend on the MPU to perform switching of the emergency power and the continuity of the data pairs of the Ethernet cable is not interrupted. This provides a less complex and more robust solution for PoE systems using all four pairs to carry power.

As illustrated, the PoE input channel 324 is coupled to a spare pair split off unit 330. In use, the split off unit 330 receives all four pairs and separates the power conductors of the spare pairs from the power and data conductors of the data pairs 332. As such, the spare pairs 333 will contain only the power component. The split off unit 330 may also contain elements for sensing power on the data pairs 332. The data conductors may be routed over the connection path of the data pairs 332. As will be described in greater detail below, the connection path of the data pairs 332 is then coupled to a spare pair combiner unit 350, which will be described in greater detail below. The power component may be transmitted to a voltage detection unit 334, which may be used to monitor incoming PoE power. In use, the voltage detection unit 334 determines if the incoming PoE power is sufficient to power all of the PoE connected devices. The voltage detection unit 334 may determine the sufficiency of the incoming PoE power and may provide an appropriate signal to maintenance personnel that PoE power is sufficient by use of visual indicators or other means. Alternatively, the PoE voltage detection unit 334 may also be communicatively coupled to an MPU 340, and in some embodiments the MPU 340 may be programmed to determine, via the PoE voltage detection unit 334, whether the incoming PoE power is sufficient to power the PoE connected devices and provide logging and communication of the PoE power status to maintenance personnel.

As illustrated, the 4P power and control module 300 may also incorporate an optional normal mains power sensing input 336 coupled to the voltage detection unit 334 for determining if normal mains power has failed. In use, the visual indicators or MPU 340 may be coupled to the voltage detection unit 334 and may be used to determine when normal mains power input 18 has failed.

The 4P power and control module 300 may also include a battery pack 345 and a battery charger 347. In use, the voltage detection unit 334 monitors the incoming PoE power to determine whether the incoming PoE power is sufficient to power all of the PoE connected devices. If the voltage detection unit 334 determines that the incoming PoE power is sufficient to power the PoE connected devices at a predetermined level, the voltage detection unit 334 may direct some power from the spare pairs 333 to the battery charger 347 in order to charge the battery pack 345. In addition, the incoming PoE power is transmitted over the connection path of the spare pairs 333 to the PoE output channel 326 via the spare pair combiner unit 350, where the spare pairs conductors are recombined with the data pairs conductors, which was transmitted over the connection path of the data pairs 332, for transmission to the PoE connected devices via the PoE output channel 326. The battery charger 347 may also be coupled to visual indicators or an MPU 340 and may be used to indicate the state of the battery charge and other information about the condition of the battery pack 345.

Alternatively, if the voltage detection unit 334 determines that the incoming PoE power is insufficient to power the PoE connected devices at the predetermined level, for example, during a power failure, the voltage detection unit 334 may draw or direct stored power from the battery pack 345 and transmit the power from the battery pack 345 over the connection path of the spare pairs 333 to the PoE output channel 326 via the spare pair combiner unit 350, where the power is recombined with the data signal, which was transmitted over the data pairs 332, for transmission to the PoE connected devices via the PoE output channel 326. The stored power may be transmitted to a voltage booster 349 for increasing the amount of voltage provided.

In this manner, when the voltage detection unit 334 detects the loss of incoming PoE power supplied, the voltage detection unit 334 may signal the battery-operated power supply to supply operational power to the PoE connected devices (e.g., LED light fixtures) via the spare pairs 333 of the Ethernet cable. As such, the spare pairs 333 of the Ethernet cables may be used to transmit emergency or backup power from a battery pack.

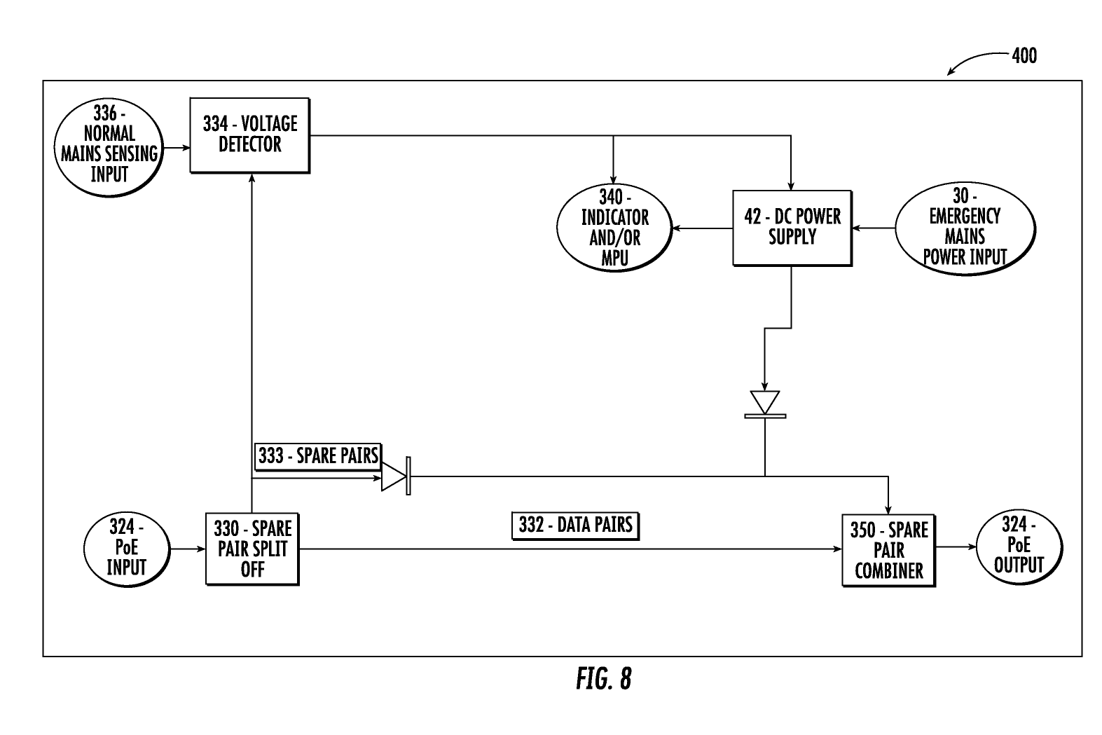

FIG. 8 illustrates an alternate, exemplary embodiment for supplying emergency, backup, supplemental and/or alternative power in a PoE lighting system utilizing “spare pairs” of wires within an Ethernet cable. Referring to FIG. 8, the PoE lighting system may include a 4P power and control module 400. As the 4P power and control module 400 is substantially similar to the 4P power and control module 300 discussed above in connection with FIG. 7, a general discussion of the elements, circuity and functionality is hereby omitted for brevity except for noted differences.

Similar to the 4P power and control module 300, the 4P power and control module 400 may include one or more PoE input channels 324 for receiving PoE power. The 4P power and control module 400 may also include one or more PoE output channels 326 for coupling to a respective PoE controlled device (e.g., an LED light fixture) via a power and communications link. The PoE input channel 324 is coupled to a spare pair split off unit 330. In use, the split off unit 330 receives all four pairs and separates the power conductors of the spare pairs 333 from the power and data conductors of the data pairs 332. As such, the spare pairs 333 will contain only the power component. The split off unit 330 may also contain elements for sensing power on the data pairs 332. The data conductors are routed over the connection path of the data pairs 332, and the data signal is coupled to a spare pair combiner unit 350.

The power may also be transmitted to a voltage detection unit 334, which may be used to monitor incoming PoE power. In use, the voltage detection unit 334 determines if the incoming PoE power is sufficient to power all of the PoE connected devices at a predetermined level. The voltage detection unit 334 may determine the sufficiency of the incoming PoE power and may provide an appropriate signal to maintenance personnel that PoE power is sufficient by visual indicators (e.g., LEDs) or other means. Alternatively, the PoE voltage detection unit 334 may be coupled to an MPU 340, and in some embodiments the MPU 340 may be programmed to determine, via the PoE voltage detection unit 334, whether the incoming PoE power is sufficient to power the PoE connected devices and provide logging and communication of the PoE power status to maintenance personnel.

As illustrated, the 4P power and control module 400 may also incorporate an optional normal mains power sensing input 336 coupled to the voltage detection unit 334 for determining if the normal mains power input has failed. In use, the visual indicators or MPU 340 may be coupled to the voltage detection unit 334 and may be used to determine when normal mains power input has failed.

As illustrated in FIG. 8, the PoE 4P power and control module 400 may also include an input power connection (e.g., an emergency mains power input 30) for receiving input power from an emergency supply of power such as an uninterruptible power supply (UPS), battery power supply, or any of a variety of renewable power sources such as solar, thermal, wind or the like. The emergency mains power input 30 may be coupled to a DC power supply 42 to condition the received incoming mains power. In use, the voltage detection unit 334 monitors the incoming PoE power to determine whether the incoming PoE power is sufficient to power all of the PoE connected devices. If the voltage detection unit 334 determines that the incoming PoE power is sufficient to power the PoE connected devices, the voltage detection unit 334 directs the incoming PoE power to be transmitted over the connection path of the spare pairs 333 to the PoE output channel 326 via the spare pair combiner unit 350, where the power is recombined with the data signal, which was transmitted over the data pairs 332, for transmission to the PoE connected devices via the PoE output channel 326.

Alternatively, if the voltage detection unit 334 determines that the incoming PoE power is insufficient to power the PoE connected devices at the predetermined level or if the normal mains power failed, for example, during a power failure, the voltage detection unit 334 may receive power from the input power connection (e.g., emergency mains power input 30) and DC power supply 42, and transmit the power from the emergency mains power input 30 (e.g., AC or DC emergency power input) and DC power supply 42 over the connection path of the spare pairs 333 to the PoE output channel 326 via the spare pair combiner unit 350, where the power is recombined with the data signal, which was transmitted over the data pairs 332, for transmission to the PoE connected devices via the PoE output channel 326.

As previously mentioned, this embodiment may also be used to provide supplemental and/or alternative power, as opposed to merely emergency power.

In some embodiments, the network connection(s) between the PoE switch 2 (or midspan PoE power source) and the power and control module 6, 106 may be employed by a user to remotely configure, monitor and manually control the power and control module 6, 106. In some embodiments, the power and control module 6, 106 may have a separate input channel (not shown) for this purpose, and may receive commands directly from a building automation system or computer that can configure, monitor and manually control the module.

In some embodiments, the power and control module 6, 106 or any of the previously described embodiments of a PoE power supply and injector may also be configured to perform regular tests required by the life safety code and may report the results via one of the network connections. Such tests may be employed to verify that the DC power transfer from Normal to Emergency power will occur properly and that sufficient current is drawn by the LED light fixtures 4 to ensure light is emitted therefrom. If a battery is used to provide Emergency power, then a battery test is required to make sure battery is charging and functioning correctly. These tests may be logged within a non-transitory memory within the MPU 40 and may be provided back to the network on demand using an input channel connected to the PoE switch 2.

Some embodiments of the disclosed device may be implemented, for example, using a storage medium, a computer-readable medium or an article of manufacture which may store an instruction or a set of instructions that, if executed by a machine (i.e., processor or microcontroller), may cause the machine to perform a method and/or operations in accordance with embodiments of the disclosure. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory (including non-transitory memory), removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

While certain embodiments have been described herein as containing certain features, circuity, and/or functionality, one of ordinary skill in the art will appreciate that features, circuity, and/or functionality can interchangeable amongst the various disclosed embodiments.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision additional modifications, features, and advantages within the scope and spirit of the claims appended hereto.

What is claimed is:

1. A power and control module for a Power over Ethernet (PoE) light emitting diode (LED) lighting system, comprising:
an input channel for receiving PoE input power from a PoE switch;
an output channel for providing PoE output power to a plurality of LED light fixtures;
a power transfer unit coupled between the input channel and the output channel for providing at least one of the PoE input power and a secondary input power to the output channel as the PoE output power;
a secondary power input unit coupled to the power transfer unit for selectively providing secondary power to the power transfer unit; and
a processor coupled to the power transfer unit, the processor programmed to control the power transfer unit to adjust an amount of the PoE input power and the secondary input power that is provided to the output channel to obtain the PoE output power;
wherein the PoE output power is an amount of power sufficient to power the plurality of LED light fixtures to achieve a predetermined brightness of each of the plurality of LED light fixtures.

2. The power and control module of claim 1, wherein the secondary input power is at least one of an emergency power input and an alternative power input.

3. The power and control module of claim 1, wherein the secondary input power is an external or internal battery and charging circuit.

4. The power and control module of claim 1, further comprising a PoE voltage detection module for detecting a voltage of the PoE input power.

5. The power and control module of claim 4, wherein the secondary input power unit comprises an emergency power supply for receiving emergency power from an emergency power source and for providing the emergency power to the power transfer unit.

6. The power and control module of claim 5, wherein the processor is programmed to:
determine when the voltage of the PoE input power is below a predetermined threshold; and
command the power transfer unit to provide the emergency power to the output channel, via the power transfer unit, in order to achieve the PoE output power.

7. The power and control module of claim 1, further comprising a line voltage detection module for detecting a voltage of a line voltage source coupled to the power and control module and the PoE switch.

8. The power and control module of claim 1, wherein the secondary input power unit comprises an alternative power detection unit for determining an alternative power of the alternative power input and for providing the alternative power to the power transfer unit.

9. The power and control module of claim 8, wherein the processor is programmed to:
determine when the alternative power is above a predetermined threshold; and
command the power transfer unit to provide the alternative power to the output channel, via the power transfer unit, in order to achieve the PoE output power.

10. The power and control module of claim 9, wherein the processor is programmed to:
determine when the alternative power is less than the PoE output power; and
command the power transfer unit to provide a portion of the PoE input power to the output channel, via the power transfer unit, so that the combination of the alternative power and the portion of the PoE input power at least equal to the PoE output power.

11. The power and control module of claim 9, wherein the processor is programmed to:
determine when the alternative power is above below the predetermined threshold; and
command the power transfer unit to provide the PoE input power to the output channel, via the power transfer unit, in order to achieve the PoE output power

12. A system for controlling an LED lighting system, comprising:
a Power over Ethernet (PoE) switch having a plurality of output channels;
a power and control module having a plurality of input channels and a plurality of output channels and a processor coupled there between, the plurality of input channels coupled to respective ones of the plurality of output channels of the PoE switch via a first plurality of power and communications links, the power and control module configured to receive PoE input power from the first plurality of power and communications links and to provide PoE output power to the plurality of output channels of the power and control module;
a first plurality of LED light fixtures coupled to respective ones of the plurality of output channels of the power and control module via a second plurality of power and communications links;
a second plurality of LED light fixtures coupled to respective ones of the plurality of output channels of the PoE switch via a third plurality of power and communications links,
wherein the processor is programmed to selectively apply at least one of: (a) the received PoE input power, and (b) an additional source of power, to obtain the PoE output power.

13. The system of claim 12, where the Power over Ethernet switch is a mid-span PoE power source.

14. The system of claim 12, wherein the PoE output power is an amount of power sufficient to power the first plurality of LED light fixtures to achieve a predetermined brightness of each of the first plurality of LED light fixtures.

15. The system of claim 14, wherein the additional source of power comprises an emergency power supply, and wherein the power and control module further comprises:
an emergency power supply unit for receiving emergency power from an emergency power supply, the emergency power supply being the additional source of power,
a PoE voltage detection module for detecting a voltage of the PoE input power, and,
a power transfer unit coupled between the plurality of input channels and the plurality of output channels, the power transfer further coupled to the emergency power supply unit for receiving the emergency power from the emergency power supply and for providing the emergency power to the plurality of output channels of the power and control module.

16. The system of claim 15, wherein the processor is programmed to:
determine when the voltage of the PoE input power is below a predetermined threshold; and
command the power transfer unit to provide the emergency power to the output channel, via the power transfer unit, in order to achieve the PoE output power.

17. The system of claim 12, wherein the additional source of power comprises a renewable power source, and wherein the power and control module further comprises:
a power detection unit for determining a power of the renewable power source and for providing the power from the renewable power source to the power transfer unit.

18. The system of claim 17, wherein the processor is programmed to:
determine when the power from the renewable power source is above a predetermined threshold; and
command the power transfer unit to provide the power from the renewable power source to the plurality of output channels of the power and control unit in order to achieve the PoE output power.

19. The system of claim 18, wherein the processor is programmed to:
determine when the power from the renewable power source is less than the PoE output power; and
command the power transfer unit to provide a portion of the PoE input power to the plurality of output channels of the power and control module so that the combination of: (a) the power from the renewable power source, and (b) the portion of the PoE input power at least equal to the PoE output power.

20. The system of claim 19, wherein the processor is programmed to:
determine when the power from the renewable power source is above below the predetermined threshold; and
command the power transfer unit to provide the PoE input power to the plurality of output channels of the power and control module in order to achieve the PoE output power.
